(19) United States
(12) Patent Application Publication
(10) Pub. No.: US 2007/0268500 A1
(43) Pub. Date: Nov. 22, 2007

(54) Tetrastitch Screening Process for Cmyk Printing

(76) Inventor: Eudes Dantas, Rio de Janeiro (BR)

Correspondence Address: PEARNE & GORDON LLP, 1801 EAST 9TH STREET, SUITE 1200, CLEVELAND, OH, 44114-3108, US

(21) Appl. No.: 10/578,997

(22) PCT Filed: Nov. 11, 2003
(86) PCT No.: PCT/BR03/00162

§ 371 Date: Mar. 31, 2007

(51) Int. Cl. G06K 15/00

(52) U.S. Cl. 358/1.9

(57) ABSTRACT

The present invention refers to a halftone screening method for printing systems, where the square dots for each color of the four subtractive colors CMYK (Cyan, Magenta, Yellow, and Black) are disposed in different vertices of the square printing cell. The screens of the different colors are not rotated: that is, they have a zero printing angle. The square dots can be arranged in a symmetrical or asymmetrical form within the vertices of the square cell.

This patent aims protect the halftone screening process of printing plates, analogical or digital, in CMYK files of computer software of output devices of all the graphic industry modalities, mostly, flexography, off-set and gravure.

Nowadays, the graphic industry relies on several printing systems of with subtractive colors CMYK (Cyan, Magenta, Yellow and Black), based in two distinct processes: the Rosette Pattern that uses traditional halftone dots aligned along the screen angles, in Rational Tangent Screening and Irrational Tangent Screening, and the Stochastic Screening Process that uses halftone dots randomly placed, in AM Screening and FM Screening.

Several formats of dots can be used in those processes of printing processes: square dot, inverted square dot, round dot, inverted round dot, euclidean dot, elliptical dot, diamond dot and line dot, it is interesting to note what all those dots, when fill 100% of theirs area, they assume the square form.

The squared dot is the more used, to produce the halftone dot, for occupying totally the printing area and for being similar to ‘pixel’ (an acronym for picture element), represents the smallest graphic unit of measurement on a screen, being more indicated for ‘Stochastic Printing’, in AM Screening and FM Screening, of that to ‘Rosette Pattern’ printing, that it needs to brighten up the problem of if placing square dots, in screen angles logarithms, in the printing cell, with the complicated Rational Tangent Screening and Irrational Tangent Screening systems.

The main characteristic of the Tetrastich Process of Printing, is take advantage the versatility of the squares dots (pixels) disposing them, geometrically, in zero angle, from each one of the four vortex, or sides, in the printing cell, that will be occupied, separately, with each one of the four colors of CMYK System, dispensing, with this, the necessity to line up them in angle. Other important characteristic is the attempt of compatibility the system of colors subtractive CMYK with the system of colors additive RGB, in computers software screening.

The position choice of the four colors CMYK in the four cell vertex is the only variable of the Tetrastich Process, destined to facilitate the problems distortion correction verified in the fidelity and printing quality, analogical or digital.

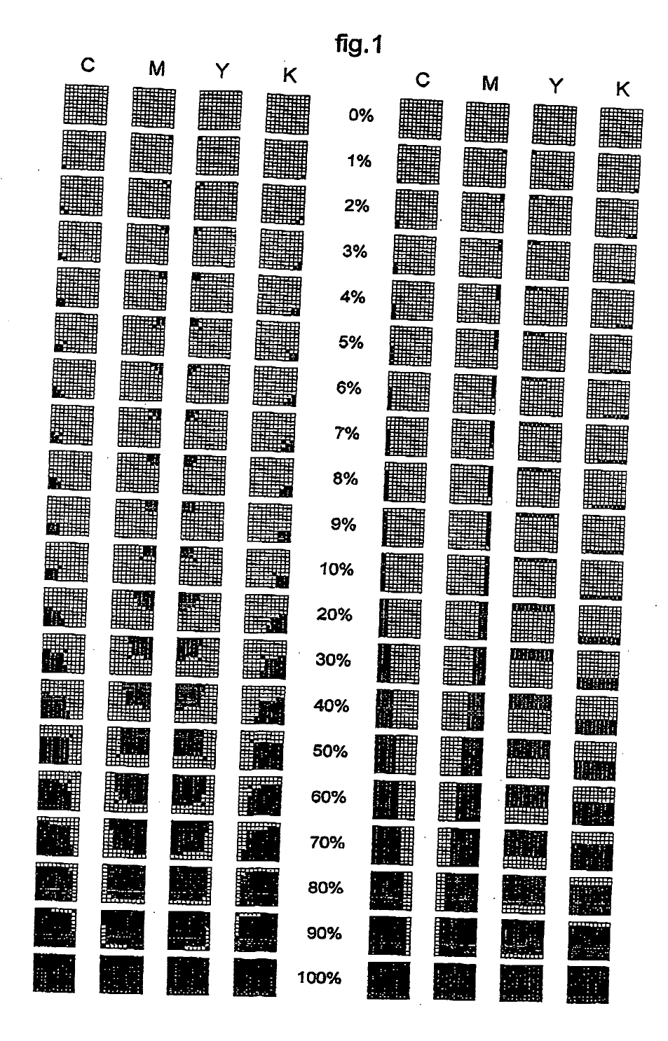

In the FIG. 1, to facilitate the understanding of the Tetrastich Process, show square cells of 100 dots (10×10), with halftone percentile varying of 1% to 99%, where was put on the black color (K), stronger, diagonally, opposite the color yellow color (Y), weaker, with the purpose of correct effects and distortion in the printing process.

The Tetrastich Process, optimize the placing from the squares dots (pixel), on the cells, requiring less memory and time of processing in computer software of output devices, promoting, of effective way, the decrease of the clear areas, remaining, and avoiding, to the maximum, the overlapping with the adjacent colors, contributing, also for effect ‘moiré’ reduction.

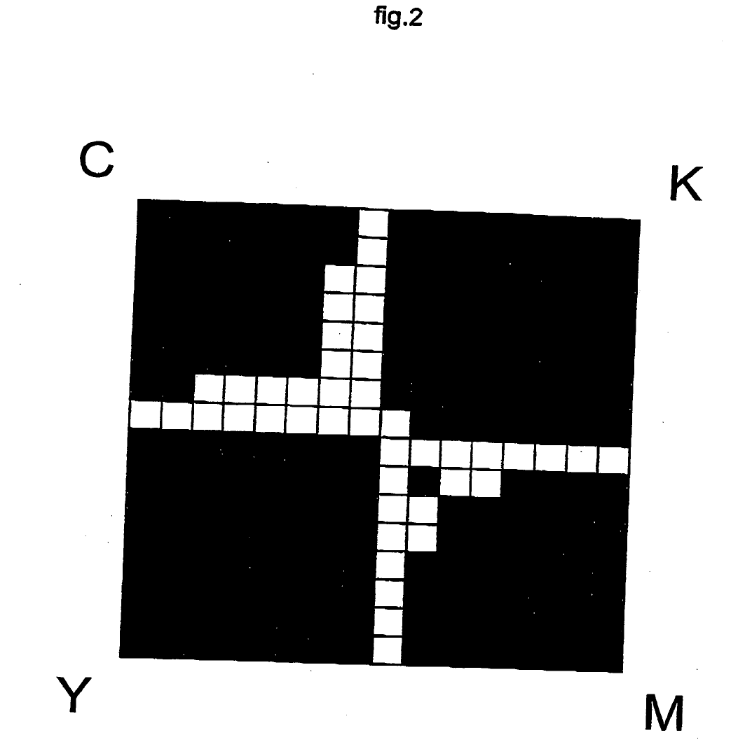

In FIG. 2, other Tetrastich Process example, printed with four registers CMYK, on top of each other in exact alignment, with square dots (pixels) arranged of symmetrical form, in a cell of 256 dots (16×16), with the percentages of the four colors represented for C 15.6% (40 points), M 17.6% (45 points), Y 25.0% (64 points) and K 24.6(63 points) in increments 0.39% where yellow (Y) and black (K) are, diagonally, the opposites. The gray lines show the dots and cell boundaries.

In the Symmetrical Tetrastich Process, if to place a percentage of 25% in each one of the four colors, will have the total elimination of the clear areas, without colors overprints. In the Rosette Pattern or in Stochastic Screening Process, the colors overprints starts to occur in percentile below 25%, composing different colors what sum the clear parts, remaining, harm the quality and complicates the forecast of the final result of any impression in CMYK, with or without additional colors.

The Tetrastich Process, will be most appropriate to implement imagesetters or platesetters, that they use technology based on Light Crystal Diode (LCD) or Digital Mirror Device (DMD), since these devices only emit halftone screen with squares dots in the pixels format.

1. The Tetrastich Process is characterized by using, in the formation of the printing cells, only, squares dots, in halftone screening of the four colors of CMYK system with, or without, additional colors.

2. The Tetrastich Process is characterized by grouping the squares dots, separately, of the four colors CMYK system, in one of the four vertexes, or sides of the printing cell, as much in the symmetrical form (left/FIG. 1), as in the asymmetrical form (right/FIG. 1).

3. The Tetrastich Process is characterized by placed, in zero angle, the squares dots of all the four colors of CMYK system, avoiding complicated calculations made in computer software of output devices.

4. The Tetrastich Process is characterized by utilize the pixel, that presents the smallest graphic unit of measurement on a screen, using to advantage its squared format for generation of the dots that compose the cells printed in the system of four colors CMYK including the additional colors, on a attempt of if compatibility the system of additives colors RGB with the system of subtractive colors CMYK.

5. The Tetrastich Process is characterized by eliminating, totally, the clear areas between the square dots, in any percentage of halftone, and for reducing, drastically, the clear zones in the printing cells in symmetrical form, with coincident registers, in two or more colors of CMYK system with, or without, additional colors.

6. The Tetrastich Process is characterized by the versatility of be utilized any density of dots by cell, with any lines quantity and in any resolution, without compromising the fidelity and colors quality, demanded by the CMYK printing with, or without, additional colors.

7. The Tetrastich Process is characterized by facilitating to the reduction of the moiré effect, by defining, better, the parameters of coincidence of the color register of CMYK system with, or without, additional colors.

8. The Tetrastich Process is characterized by simplicity in the position exchange, of four colors CMYK, between the four vertexes, or sides, of the printing cell, increasing, consequently, the processing calculations speed in the computer software.

9. The Tetrastich Process is characterized by covering 100% of the area of its dot, in its minimum percentage, and 100% of the area of its cell, in its maximum percentage, covering, always, all the area, square, that they occupy.

10. The Tetrastich Process is characterized by demanding memory low quantaty, increasing the speed of processing of the halftone screening in computer software output, for imagesetters and platesetters, that use Laser technology, LCD, DMD or any another one.
